(19) United States
(12) Patent Application Publication
(10) Pub. No.: US 2025/0275549 A1
(43) Pub. Date: Sep. 4, 2025

(54) DIETARY OILY COMPOSITION CONTAINING 7-DEHYDROCHOLESTEROL, PREVITAMIN D3 AND VITAMIN D3 - ASSOCIATED PRODUCTS

(71) Applicant: NUTRI'EARTH, Lomme (FR)

(72) Inventors: Jérémy DEFRIZE, Hallennes les Haubourdin (FR); Thomas DORMIGNY, Meurchin (FR); Charles-Antoine DESTAILLEUR, Sailly sur La Lys (FR)

(21) Appl. No.: 18/846,387

(22) PCT Filed: Apr. 5, 2023
(86) PCT No.: PCT/EP2023/058995

§ 371 Date: Sep. 12, 2024

(30) Foreign Application Priority Data
Apr. 13, 2022 (FR) FR2203409

(51) Int. Cl. A23D 9/007; A23L 33/155

(52) U.S. Cl. CPC A23D 9/007; A23L 33/155

(57) ABSTRACT

The present invention relates to an edible oil composition containing vitamin D3, 7-dehydrocholesterol and previtamin D3. According to an implementation of the invention, the edible oil composition contains a mass of 7-dehydrocholesterol per 100 g of composition equal to or greater than one of 5 mg, 10 mg, 15 mg, 20 mg, 21 mg, 22 mg, 23 mg, 23.5 mg, 24 mg, 24.5 mg and 25 mg.

### TECHNICAL FIELD

The present invention relates to edible oil compositions which contain vitamin D3.

### PRIOR ART

Vitamin D3 is routinely extracted from lanolin or lichen.

Extracting it from lanolin or lichen requires the use of solvents. Vitamin D3 extracted from lanolin or lichen is then mixed with a vegetable oil which is frequently rapeseed oil.

In both cases, the solvents remain at least in trace amounts in the finished product.

The aforementioned vitamin D3 oil compositions are not always readily absorbed by mammals, in particular humans.

They are also fragile due to the oxidation of lipids, particularly unsaturated lipids, by oxygen in the air. Light also causes these oils to significantly deteriorate, creating activated species (free radicals) which generate oxidation chain reactions that are sometimes self-catalysed in the oil.

UV rays (A, B and C) are known to form free radicals, which give rise to self-sustaining chemical chain reactions. When these compositions are exposed to light, they deteriorate very quickly, even if they are then kept in the dark, due to the rapid formation of activated species (free radicals).

One object of the present invention is to propose a new oil composition containing vitamin D3 which is readily absorbed by the body and/or which has a more stable concentration of vitamin D3 over time than the oil compositions containing vitamin D3 extracted from lanolin and/or lichen.

### SUMMARY OF THE INVENTION

The present invention relates to an edible oil composition containing vitamin D3, 7-dehydrocholesterol and previtamin D3. Characteristically, according to the invention, it contains a quantity of 7-dehydrocholesterol per 100 g of composition equal to or greater than 5 mg; 10 mg; 15 mg; 20 mg; 21 mg; 22 mg; 23 mg; 23.5 mg; 24 mg; 24.5 mg; 25 mg. Such an oil has a stable vitamin D3 content over time. Indeed, as it contains previtamin D3 and 7-dehydrocholesterol, these two compounds can be transformed in situ into vitamin D3, replacing vitamin D3 that has deteriorated, in particular through oxidation. Without the applicant being bound by the explanation that follows, the rearrangement reaction which leads to the formation of vitamin D3 from previtamin D3 does not appear to have been studied much; it is probably a reversible reaction leading to an equilibrium, where the kinetics and concentrations of the species at equilibrium depend on the medium in which it takes place. Thus, the aforementioned value of 7-dehydrocholesterol in an edible oil composition enables the composition to be readily preserved over time and/or helps it to be absorbed, in particular in mammals.

The quantity of 7-dehydrocholesterol per 100 g of composition can be less than or equal to 26 mg, 27 mg, 28 mg, 29 mg or 30 mg.

The composition advantageously has a peroxide value of less than 4, in particular less than or equal to 2.5; 2.4; 2.3; 2.2; 2.1; 2; 1.9; 1.8; 1.7; 1.6; 1.5; 1.4; 1.3; 1.2; 1.15, or 1.10 and/or an anisidine value of less than or equal to 1.1; 1.07; 1.05; 1.02; 1.00; 0.97; 0.95; 0.90; 0.87; 0.85; 0.82; 0.80; 0.77; 0.75; 0.72; 0.70; 0.67; 0.65; 0.62; 0.60; 0,57; 0.55; 0.52; 0.50; 0.47; 0.45; 0.43; 0.40; 0.37; 0.35; 0.33; 0.30; 0.27; 0.25; 0.22; 0.20; 0.17; 0.15; 0.12; 0.10; 0.07; 0.05; 0.02.

The aforementioned peroxide value ensures that the composition does not oxidize further as a result of reactions caused by free radicals, which are in any case inevitable.

The anisidine value ensures minimal lipid oxidation and a stable lipid profile (lipid composition). The applicant has demonstrated that the lipids present are important both for vitamin D3 stability and for the bioavailability (absorption) of vitamin D3 and any other components that may have a pharmaceutical or biological reaction.

The vitamin D3 content per 100 g of the composition according to the invention is, in all embodiments, greater than or equal to 100 μg, 200 μg, 250 μg, 500 μg, 700 μg, 900 μg, 1000 μg, 1200 μg, 1300 μg, 1500 μg, 1700 μg or 1900 μg. The vitamin D3 concentration is, in all embodiments, less than or equal to 2500 μg or 2000 μg for 100 g of composition.

According to a first preferred embodiment, the composition according to the invention contains for 100 g a vitamin D3 quantity greater than or equal to 100 μg and less than or equal to 350 μg and advantageously equal to 250 μg and has an oxidation value of less than 1.10 and an anisidine value of less than 0.5. In this first embodiment, the quantity of 7-dehydrocholesterol is comprised between 22 mg and 26 mg and is preferably equal to 24 mg.

According to a second preferred embodiment, the composition according to the invention contains for 100 g a vitamin D3 quantity greater than or equal to 1500 μg and less than or equal to 2500 μg or 2000 μg and advantageously equal to 1700 μg and has an oxidation value of less than 1.15 and an anisidine value of less than 0.5. In this second embodiment, the quantity of 7-dehydrocholesterol is comprised between 22 mg and 26 mg and is preferably equal to 23.8 mg. According to a third preferred embodiment, the composition according to the invention contains for 100 g a vitamin D3 quantity greater than or equal to 1500 μg and less than or equal to 2500 μg and advantageously equal to 1700 μg and has an oxidation value of less than or equal to 3.5 and in particular equal to 2.5 and an anisidine value of less than or equal to 1.5 and in particular equal to 1.1. In this third embodiment, the quantity of 7-dehydrocholesterol is comprised between 22 mg and 26 mg and is preferably equal to 23.8 mg.

In one embodiment that can be combined with any one of the aforementioned embodiments, the composition contains at least 25% by mass of polyunsaturated fatty acids and at least 40% by mass of monounsaturated fatty acids. These fatty acids contained in particular in these proportions contribute to the bioavailability of the composition according to the invention. Advantageously, in all embodiments of the composition according to the invention, it can have a cholesterol/phytosterol mass ratio equal to or greater than 135 and equal to or greater than 210 and in particular equal to 173. This ratio also contributes to the bioavailability/absorption of the vitamin D3 in particular.

Advantageously, in all embodiments, the composition also contains vitamin A and/or vitamin E and/or vitamin K. Vitamins A and K are antioxidants which will help slow down the oxidation of the composition or contribute to the bioavailability of vitamin D3.

It advantageously contains at least 15 μg of vitamin E per 100 g of composition and in particular at least 3.00 μg of vitamin K1 per 100 g of composition.

Advantageously, in all embodiments, it has a linoleic acid (omega 6)/alpha-lineolenic acid (omega 3) mass ratio equal to or greater than 18 and equal to or less than 27.5.

Advantageously, in all embodiments, it contains a quantity of beta-sitosterol greater than or equal to 270 μg and less than or equal to 420 μg per 100 g of composition. Beta sitosterol is known to combat hypercholesterolaemia; it is known to have anti-cancer and immunomodulating properties.

Advantageously, in all embodiments, it contains oil obtained by cold extraction from beetle larvae chosen in particular from Tenebrio molitor, Alphitobius diaperinus, Tribolium castaneum and mixtures of at least two of these beetle species.

The present invention also relates to a product chosen from emulsions, capsules, liposomes and colloids which contains the composition according to the invention.

### Definitions

The term 7-dehydrocholesterol constitutes the compound of formula 1 below:

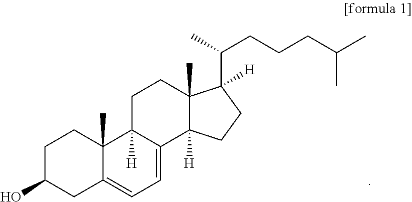

The term previtamin D3 designates the compound of formula 2 below:

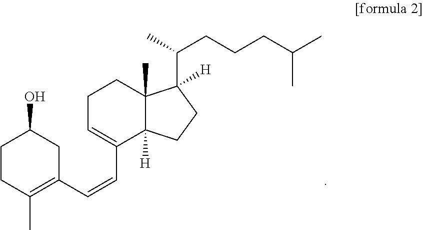 [SMILES: CC1=C(/C=C\C2=CCC[C@]3(C)[C@@H]([C@H](C)CCCC(C)C)CC[C@@H]23)C[C@H](O)CC1]

The previtamin D3 content can be calculated from the 7-dehydrocholesterol and vitamin D3 content before and after irradiation treatment. The maximum quantity of vitamin D3 that can be produced by irradiation is equal to the quantity of 7-dehydrocholesterol contained before irradiation. The quantity of previtamin D3 corresponds to the difference between the quantity of 7-dehydrocholesterol having disappeared as a result of the irradiation and the quantity of vitamin D3 produced by irradiation.

The term vitamin D3 designates the compound of formula 3 below:

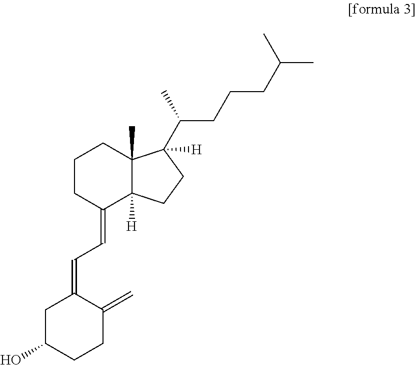 [SMILES: C=C1CC[C@H](O)C/C1=C/C=C1\CCC[C@]2(C)[C@@H]([C@H](C)CCCC(C)C)CC[C@@H]12]

The term “edible” indicates that the composition can be ingested over a given period by a mammal chosen, for example, from humans, dogs, cats, horses and donkeys without causing any major problems; the composition complies with the regulatory conditions in force for animal and/or human nutrition, in particular with regard to the total oxidation value.

The phrasing “contains beetle oil” indicate that the composition according to the invention has the same composition as an oil obtained, for example, by cold extraction (centrifugation) from beetle larvae, apart from the quantity of vitamin D3 and/or 7-dehydrocholesterol and/or previtamin D3, which differ(s) from that/those of beetle oil.

### DETAILED DESCRIPTION—EXAMPLES

Two examples of producing an oil according to the invention will now be described.

The larvae treatment and oil extraction phases are the same for both examples.

Only the UV treatment phase is different.

### Larvae Treatment

### Fasting Step (Optional)

The fasting phase for larvae aged between 8 and 12 weeks lasts 24 hours. This step involves purging the intestinal contents of the larvae. For this, the larvae are placed in a tray (plastic or stainless steel). The thickness of the larvae does not exceed 1 cm. It takes place at a temperature comprised between 16 and 24° C. and a humidity between 35 and 70%.

### Freezing Step (Optional)

This step enables the larvae to be stunned before the following step: slaughter. It takes place at −18° C. for 5 minutes. This step does not have any specific impact. The procedure for extracting the oil with or without this step results in the same final product, with the same nutritional values and the same microbiological and toxicology results.

### Blanching Step. (Optional)

Fresh larvae are blanched in boiling water (100° C.) for one minute.

### Extracting the Oil Phase

### Step 1. Centrifugation

This stage involves placing the whole, blanched, dehydrated or crushed larvae in a centrifuge.

For one cycle, the decanter centrifuge is programmed at a given centrifugal force for 10 minutes. Inside the rotating conical drum of the centrifuge is a spool that rotates a few rpm slower, pushing solid materials out of the system and allowing solid-liquid-liquid separation: cake (solid)+oily liquid phase+aqueous liquid phase. It is the oily liquid phase which is used in the rest of the process and is called “oil”.

### Blanching Step. (Optional)

After centrifugation and extraction, the oil is collected in a vessel approved for contact with food, passing through a filter to remove foreign bodies and solid residues.

### Step 2. Heat Treatment

The filtered oil obtained in this way is then subjected to a heat treatment that heats the oil to 90° C. for a period of time to ensure that the oil complies with regulations; at this stage, the oil is considered a processed product suitable for human or animal consumption. In particular, it contains no live bacteria and does not have an oxidation value (TOTOX) above 26.

The oil obtained contains less than 0.25 μg of vitamin D3 for 100 g of oil and around 24 mg of 7-dehydrocholesterol for 100 g of oil.

### Vitamin D3 Enrichment

### Step 3. UV Exposure

The processed TM oil is first distributed in stainless steel trays (GN 1/1; 530×325×20 mm). The stainless steel does not deteriorate under the effect of UV rays. The oil is 1 cm thick which constitutes 1 kg of oil per tray. The trays containing 1 kg of TM oils are then placed under a UV neon light at 21 cm for 3.45 minutes for oil 1, which contains 250 μg/100 g of oil, and 30 minutes for oil 2, which contains 1700 μg/100 g of oil, in a specific room at a temperature comprised between 20° C. and 25° C. and a relative humidity of between 30 and 60%. 18 W UV neon lights (MIGRO UVB 310 with 75% UVB and 25% UVA, peak spectrum at 310 nm). The UV light intensity reaches 110 paw/cm² at 21 cm.

It is also possible to obtain the composition according to the invention by irradiation of an oil obtained according to the method described in document WO 2018122476 A1.

### Step 4. Centralization & Uniformization

After UV exposure, the oil in each stainless steel tray is transferred to a vessel with a lid that is approved for contact with food. The content of the vessel is then stirred so as to achieve uniformity throughout the entire vessel.

### Step 5. Filtration & Packaging

The oil is filtered immediately after UV treatment and immediately packaged in sealed bottles in order to prevent any risk of oxidation by oxygen in the air. For packaging, we use single-use opaque bottles that are suitable for contact with food and adapted to the desired volumes. Once the bottle has been filled with the desired volume, the reservoir valve is closed and the bottle is capped. Once the bottle has been closed, the risk of oil contamination is virtually nil. The maximum time between the end of UV treatment and bottle closure after bottling is 60 min.

### Step 6. Storage

Before being dispatched, the bottles of oil are stored in a dedicated room. The ambient temperature is comprised between 1° and 20° C. and the humidity is between 35 and 70%. This room is kept in darkness.

Table 1 below shows the compositions of the two oils. These two oils were obtained by irradiation of Tenebrio molitor oil marketed as a food product.

TABLE 1

| | | Oil 1 | Oil 2 |
|---|---|---|---|
| Average | Vitamins | | |
| values | Vitamin D3 | 250 μg/100 g | 1700 μg/100 g |
| (for | Vitamin A | <21 μg | |
| 100 g | Vitamin E | 19.37 μg | |
| of TM | Vitamin K1 | 3.56 μg | |
| oil) | Choline | <10 mg | |
| | Fat | | |
| | Saturated fatty acids | 22.91 g | |
| | Monounsaturated fatty acids | 48.96 g | |
| | Polyunsaturated fatty acids | 27.83 g | |
| | Trans | <0.32 g | |
| | Linolenic acid (w3) | 1.16 g | |
| | Linoleic acid (w6) | 26.55 g | |
| | Oleic acid | 46.28 g | |
| | Sterols | | |
| | 7-DHC | 24 mg/23.8 mg | |
| | Phytosterols | 1760 μg | |
| | Brassicasterol | 1260 μg | |
| | Campesterol | 156 μg | |
| | Beta-sitosterol | 344 μg | |
| | Cholesterol | 304 mg | |
| | Squalene | 60.8 μg | |
| | Co-enzymes | | |
| | Ubiquinol/Co-Q10 | <0.5 mg | |
| | Other components | | |

| | |
|---|---|
| Fibers | <3 g |
| Ash content | <0.3 g |
| Polyphenols | <10 mg |
| Peroxide value meqO₂/kg fat | 1.10/1.15 |
| p-Anisidine | <0.5/<0.5 |
| Totox value | <2.7/<2.8 |

Peroxide value (PV). This value assesses the degree of oxidation of the unsaturated fatty acids in the fat. This value indicates the onset of oxidation. Peroxides are formed from the free radicals that are created in the initiation phase of the oxidation reaction. The peroxide value is determined according to NF EN ISO 660 by titrimetry. It is measured in meqO₂ by kilogram of composition.

Anisidine value (AV). This value corresponds to the measurement of the secondary oxidation products of the fat. This value measures the quantity of aldehydes (mainly α, β-unsaturated aldehydes). The anisidine value is measured by spectrophotometry according to ISO 6885:2016.

The TOTOX value (TOTal OXidation) is a measurement of the oxidation of the oil on the basis of the peroxide value and the anisidine value. TOTOX value=(2×PV)+AV. A product is considered to be harmful if the TOTOX value is greater than 26.

Sterols including 7-DHC, which is the precursor of vitamin D3, are quantified by gas chromotography with a flame ionization detector (GC-FID (T-AA08-WO3638)).

The lipid profile is determined by gas chromotography with a flame ionization detector (GC-FID (T-AA08-WO3638)).

Vitamin D3 is quantified by liquid chromotography with diode array detection (EN 12821:2009, LC-DADLC-DAD).

Vitamin E is quantified by liquid chromotography with fluorescence detection (EN 12822:2014, LC-FLD).

Fibers are quantified by an enzymatic gravimetric method (COFRAC test 1-0287).

The other components are quantified by conventional methods.

### Biological Data

### Absorption Measurement

### Experimental Protocol

### Step 1: Animal Experimentation

After a period of acclimatization, 3 groups of adult male Wistar rats were subjected to lymph duct shunting (6 to 8 rats per group) and then intubated with different oils.
TM insect oil (25 μg/ml vitamin D3, referred to in this report as “TM oil”)
Lichen vitamin D3 (marketed by D.plantes Laboratoire) diluted in virgin rapeseed oil so as to obtain a final vitamin D3 concentration of (25 μg/ml) (referred to in this report as “VitD3 Lichen”)
Lanolin vitamin D3 (marketed by D.plantes Laboratoire) diluted in virgin rapeseed oil so as to obtain a final vitamin D3 concentration of (25 μg/ml) (referred to in this report as “VitD3 Lanolin”)

The various oils were administered via gastric intubation so as to provide an equivalent of 50 μg of vitamin D3/rat. Mice in all 3 groups received the same amount of vitamin D3 and oil.

A 4th control group of 3 animals intubated with saline also underwent lymph duct shunting.

This group will serve as a reference in terms of composition and content of fatty acids and vitamin D of the lymph under fasting conditions.

For each group of animals, lymph was collected over 6 hours to determine its vitamin D3 concentration as a function of the oil ingested.

### Step 2: Intestinal Absorption of D3 Vitamin

The lymphatic content of cholecalciferol was determined by high-performance liquid chromotography equipped with a diode-array UV detector.

The intestinal absorption rate (T) of vitamin D was calculated in comparison with a reference with an absorption rate of 100%:

$$\begin{matrix}T = ( RL / RH ) \times 100 \\ where : \\ RL = amount of vitamin D in lymph / reference amount in lymph \\ RH = amount of vitamin D in the formula ingested / reference am ount in the formula ingested .\end{matrix}$$

### Results

The lymphatic concentration of vitamin D3 was determined for each group of animals. The results are shown in Table 2.

As expected, in the control animals not given vitamin D3, the lymph has no vitamin D3.

TABLE 2

| | VitD3 lymph |
|---|---|
| Group | (ng/ml/μg of vitD3 ingested) |
| TM oil (n = 6) | 4.3 ^{a} ± 1.4 |
| “VitD3-lichen” oil (N = 8) ** | 2.1 ^{b} ± 1.3 |
| “VitD3-lanolin” oil (N = 8) ** | 1.3 ^{b} ± 0.7 |
| Control group (no vitamin D3; | n.d.* |
| N = 3) | |

Averages marked with different letters are significantly different (p < 0.05), univariate ANOVA followed by Tukey's HSD test
*nd = not detectable
** Lichen or lanolin vitamin D3, diluted in virgin rapeseed oil

Better absorption of vitamin D3 contained in the oil according to the invention can be observed.

### Storage

Table 3 below shows the storage results for the aforementioned oils (oil composition according to the invention (TM), oil composition containing vitamin D3 extracted from lichen and oil composition containing vitamin D3 extracted from lanolin).

The storage conditions are as follows: Temperature: 4° C. in the dark, humidity: between 50 and 70%

TABLE 3

| | D3 T = 0 (% T0) | D3 T = 1 M (% T0) |
|---|---|---|
| D3 TM | 100 | 100 |
| D3 lichen | 100 | 72.72727273 |
| D3 lanolin | 100 | 85.95744681 |

Table 3 shows that the oil composition according to the invention contains the same amount of vitamin D3 even after a month of storage in the aforementioned conditions, which is not the case for the other two oil compositions.

1. An edible oil composition containing vitamin D3, 7-dehydrocholesterol and previtamin D3, wherein it contains a mass of 7-dehydrocholesterol per 100 g of composition equal to or greater than one selected from a group consisting of 5 mg; 10 mg; 15 mg; 20 mg; 21 mg; 22 mg; 23 mg; 23.5 mg; 24 mg; 24.5 mg; and 25 mg.

2. The composition according to claim 1, further comprising a peroxide value of less than 4, and an anisidine value of less than or equal to 1.1.

3. The composition according to claim 1, further comprising a quantity of vitamin D3 per 100 g of composition equal to or greater than 100 μg.

4. The composition according to claim 1, wherein it contains at least 25% by mass of polyunsaturated fatty acids and at least 40% by mass of monounsaturated fatty acids.

5. The composition according to claim 1, further comprising a cholesterol/phytosterol mass ratio equal to or greater than 135.

6. The composition according to claim 1, wherein it also contains vitamin A and/or vitamin E and/or vitamin K.

7. The composition according to claim 7, wherein it contains at least 15 μg of vitamin E per 100 g of composition and at least 3.00 μg of vitamin K1 per 100 g of composition.

8. The composition according to any one of the preceding claims, characterized in that it has a linoleic acid (omega 6)/alpha-lineolenic acid (omega 3) mass ratio equal to or greater than 18 and equal to or less than 27.5.

9. The composition according to claim 1, wherein it contains a quantity of beta-sitosterol greater than or equal to 270 μg and less than or equal to 420 μg per 100 g of composition.

10. The composition according to claim 1, wherein it contains oil obtained by cold extraction from beetle larvae selected from a group consisting of Tenebrio molitor, Alphitobius diaperinus, Tribolium castaneum and mixtures of at least two of these beetle species.

11. A product chosen from emulsions, capsules, liposomes and colloids, wherein it contains the composition according to claim 1.

12. The composition according to claim 1, wherein the peroxide value is one selected from a group consisting of 2.5, 2.4, 2.3, 2.2, 2.1, 2, 1.9, 1.8, 1.7, 1.6, 1.5, 1.4, 1.3, 1.2, 1.15 and 1.10.

13. The composition according to claim 2, wherein the anisidine value is less than or equal to one selected from the group consisting of: 1.07, 1.05, 1.02, 1.00, 0.97, 0.95, 0.90, 0.87, 0.85, 0.82, 0.80, 0.77, 0.75, 0.72, 0.70, 0.67, 0.65, 0.62, 0.60, 0.57, 0.55, 0.52, 0.50, 0.47, 0.45, 0.43, 0.40, 0.37, 0.35, 0.33, 0.30, 0.27, 0.25, 0.22, 0.20, 0.17, 0.15, 0.12, 0.10, 0.07, 0.05, 0.02.

14. The composition according to claim 3, wherein the quantity of vitamin D3 per 100 g of composition equal to or greater one selected from a group consisting of, 200 μg, 250 μg, 500 μg, 700 μg, 900 μg, 1000 μg, 1200 μg, 1300 μg, 1500 μg, 1700 μg and 1900 μg.

15. The composition according to claim 5, wherein the cholesterol/phytosterol mass ratio is in a range of 135 to 210.

16. The composition according to claim 15, wherein the cholesterol/phytosterol mass ratio is equal to 173.
